(19) United States
(12) Patent Application Publication
(10) Pub. No.: US 2024/0221061 A1
(43) Pub. Date: Jul. 4, 2024

(54) MAKEUP VIRTUAL TRY ON METHODS AND APPARATUS

(71) Applicant: L'Oreal, Paris (FR)

(72) Inventor: Edmund Phung, Toronto (CA)

(73) Assignee: L'Oreal, Paris (FR)

(21) Appl. No.: 18/396,334

(22) Filed: Dec. 26, 2023

Related U.S. Application Data
(60) Provisional application No. 63/435,603, filed on Dec. 28, 2022.

(30) Foreign Application Priority Data
Apr. 11, 2023 (FR) 2303587

(51) Int. Cl. G06Q 30/0601; A45D 44/00; G06T 11/00; G06T 17/20; G06V 10/82; G06V 40/16

(52) U.S. Cl. CPC G06Q 30/0643; A45D 44/005; G06Q 30/0631; G06T 11/001; G06T 17/20; G06V 10/82; G06V 40/171; A45D 2044/007

(57) ABSTRACT

There is provided methods, systems and techniques (e.g. in embodiments) for rendering effects such as a makeup effect that adjusts a hue of the effect responsive to a hue in an environment. The makeup effect can be rendered to an input image as a component of a virtual try on experience. Operations can process sclera of an eye to determine a reference hue and adjust the color of the effect toward a warm color or a cool color responsive to the reference hue. Glitter effects can be computed and rendered.

### CROSS-REFERENCE

This application claims a domestic benefit of U.S. Provisional Application No. 63/435,603, filed 28 Dec. 2022, the entire contents of which are incorporated herein by reference. This application also claims priority to France Application No. FR 2303587, filed 11 Apr. 2023, the entire contents of which are incorporated herein by reference.

### FIELD OF INVENTION

This disclosure relates to image processing such as using neural networks and to generating output images to virtual try on a product or service by applying simulating effect(s) to one or more detected objects in an input image.

### BACKGROUND

Deep learning techniques are useful to process images, including a series of video frames, to localize one or more objects in the images. In an example, the objects are facial features comprising portions of a user's face. Image processing techniques are also useful to render effects in association with such objects such as to augment reality for the user. One example of such an augmented reality is providing a virtual try on (VTO) that simulates the application of a product (or a service) to an object. Product simulation in the beauty industry includes simulating makeup, hair, and nail effects. Other examples can include iris localization and the simulation of a color change thereto such as by a colored contact lens. These objects and simulations as well as others will be apparent.

In many VTO scenarios, users use their own camera equipped computing devices such as a smartphone, tablet or other computing device with a camera (e.g. a web cam) to generate input images and do so under lighting conditions that are varied and uncontrolled.

Increasing complex simulated effects are desired, for example, to better simulate real product effects or to otherwise augment reality. For example, a real product effect may comprise a glitter effect or a special lighting effect. An augmented realty simulation may comprise a shaping effect that simulates a change in shape (e.g. a warping) of a facial feature or the application of a beauty filter. The shape change may be as a result of a simulation of a professional service (e.g. a beautician, or a plastic surgeon) or result from a personal activity such as self-care or for entertainment. Examples can include a brow shaping, a nose shaping (nostril slimming, bridge slimming), face contour change, eye or eyelid change (e.g. vertical or horizontal eye enlargement), etc.

Improved techniques are desired to process images to facilitate providing augmented realities including VTO experiences.

### SUMMARY

There is provided methods, systems and techniques (e.g. in embodiments) for rendering effects such as a makeup effect that adjusts a hue of the effect responsive to a hue in an environment. The makeup effect rendered to an input image of a face as a component of a virtual try on experience. Operations can process sclera of an eye to determine a reference hue and adjust the color of the effect toward a warm color or a cool color responsive to the reference hue.

There is provided, in an embodiment, a computer implemented method comprising executing by one or more processors the steps of: processing a sclera in a face of an input image to determine a reference hue of the face; adjusting a hue of a makeup effect in response to the reference hue to render an adjusted makeup effect to the input image; and presenting an output image defined from the input image and the adjusted makeup effect via a user interface as a component of a virtual try on experience.

There is provided, in an embodiment, a system comprising: a rendering pipeline configured via circuitry to: process a sclera in a face of an input image to determine a reference hue of the face; adjust a hue of a makeup effect in response to the reference hue to render an adjusted makeup effect to the input image; and provide an output image defined from the input image and the adjusted makeup effect for presenting via a user interface as a component of a virtual try on experience.

There is provided, in an embodiment, a computer implemented method comprising executing by one or more processors the steps of: processing a face of an input image to determine a location of a facial feature, the input image processed by a face tracking engine comprising at least one deep neural network to localize facial features; rendering a makeup effect in association with the facial feature, the makeup effect including a glitter effect defined from pre-computed texture and light environment maps for locating and lighting the glitter effect; and providing an output image defined from the input image and the makeup effect for presenting via a user interface as a component of a virtual try on experience.

There is provided, in an embodiment, a computer implemented method comprising executing by one or more processors the steps of: pre-computing texture and light environment maps for locating and lighting a glitter effect as a component of a makeup effect to be rendered in association with a facial feature localized by a face tracking engine of a make-up virtual try on application; and providing the pre-computed texture and light environment maps to a rendering pipeline of the make-up virtual try on application to render to an output image for display the makeup effect having the glitter effect.

These and other method and system aspects among other aspect types will be apparent.

### BRIEF DESCRIPTION OF DRAWINGS

FIG. 1 is an illustration of an input image showing a typical scene for a VTO experience.

FIG. 2 is an illustration of an eye providing a sclera as a referential in accordance with an embodiment herein.

FIG. 3 is an illustration of a computing environment, in accordance with an embodiment, such as for practicing one or more method aspects.

FIG. 4 is a screenshot of a user interface (UI) for parameters settings in accordance with an embodiment.

FIG. 5 is a flowchart of operations, in accordance with an embodiment, such as for a computing device of FIG. 3.

FIG. 6 shows an example of a face image (e.g. a cropped image of a face) annotated with groups of face points.

FIGS. 7A and 7B are illustrations of a face warping construct 700, in accordance with an embodiment, to warp a brow.

FIGS. 8A and 8B are flowcharts of operations in accordance with an embodiment, such as for a computing device of FIG. 3.

FIGS. 9A, 9B and 9C are illustrations of 3D polygon meshes comprising eye meshes and lip mesh for eye and lip related facial features, in accordance with an embodiment.

FIG. 10 is an illustration of an eye region 1000 having an eye mask 1002 in accordance with an embodiment.

FIG. 11 is a flowchart of operations in accordance with an embodiment, such as for a computing device of FIG. 3.

### DETAILED DESCRIPTION

### Lighting Adaptation

In an embodiment, a VTO application executed by a computing device comprise a tracking engine and a rendering engine. An input image provided to a virtual try-on application is considered a scene. Typically this scene is composed of one face, a surrounding environment (such as a background) and some other objects. A scene also includes one or more lights sources that will alter the scene's colors and brightness. How these sources alter the scene depends on their nature: natural (as directed light from the sun), or artificial (such as a light bulb or a neon). The alteration might be a shift in the tint (hue) specifically for artificial light, or differences in brightness/darkness, and occasionally some artifacts such as shadows. In an embodiment, a VTO application can improve the realism and the accuracy of the makeup applied on a user's face by accounting for these light sources.

Correction for lighting for the purposes of a makeup or skin effect to be applied to an image is described in U.S. Ser. No. 10/892,166 B2, granted Jan. 12, 2021, and entitled “System and Method for Light Filed Correction of Colored Surfaces in an Image”, the entire contents of which are incorporated herein by reference (hereinafter “the '166 patent”). In an embodiment, a VTO application utilizes color correction as described in the 166 patent and as further adapted as described herein.

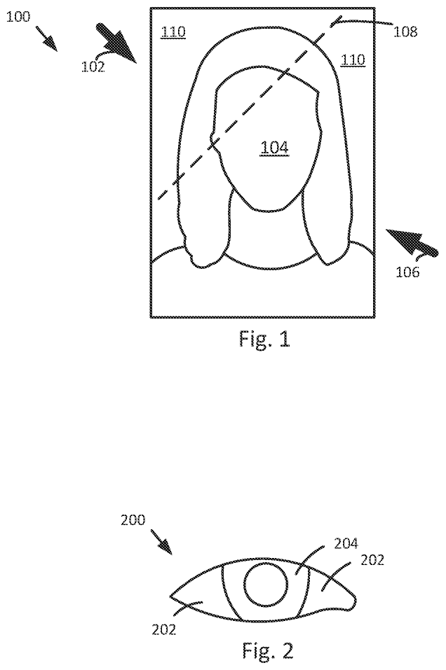

Being able to infer the shift of the hue and brightness of an image without any reference to the lighting sources used or without an external referential is very difficult. Humans tend to do this naturally when an image is not within normal conditions, and this might seem a simple problem to solve. However for a computer the task might seem very complicated. In an example FIG. 1 shows an illustration of an input image 100, where cold natural light 102 may originate from a source in a top left side and be directed diagonally toward a central face 104. In the same image, artificial warm light 106 may originate from a lower right side source and be directed diagonally upward toward the face 104. As a result a hue shift in tone and a brightness shift such as represented by diagonal dotted line 108 is present in the skin tones etc. of the face. The shift is represented by a straight line (108) but such a shift need not be straight nor as abrupt.

Recoloring algorithms can have difficulty to detect a hue shift and render a realistic color—often there is insufficient enough data to infer a general tone, and using external reference (such as the background) could lead to error. For example a background (e.g. regions 110 outside the region of the human subject) can be clearly shifted toward cool colors, whereas the face 104 can be generally warmly lit.

While difficult, inferring the hue shifting is not impossible, techniques exist. In one prior example, the technique requires using a Machine Learning model trained using a large database of reference images where the lighting conditions are known. Then comparing an image to this set of references allows a device to approximate the light in the scene and use the output to adapt the makeup rendering. This approach has similarities to how a human's brain works, by comparing a scene light to a set of memories and adapting the perception. However these models are expensive to run and are usually unadapted to live experiences. In an embodiment, a target for a VTO application is to execute at over 20 FPS (frames per second) on a mobile device such as a smartphone or tablet where the VTO application is web browser-based. Such a target is usually incompatible with this technique using a machine learning approach to color.

Other techniques to adapt the brightness and hue shift require using an external referential such as a color grid where the colors are calibrated and known in advance. This is known as a Color Checker, but such is impractical for many VTO use scenarios. While such techniques work very well and are fast to compute, they require the colors grid to be available during the full experience (in case the lighting changes), but more importantly it requires to distribute such a checker to every user. Because the VTO experience is run by any user, this kind of color grid is not an effective option.

Instead of relying on color checker, and machine learning models, in an embodiment according to the novel teachings herein, color operations use a referential available for any user, namely, sclera. As shown in FIG. 2 providing an illustration of an eye 200, the sclera 202 is the white part of users' eyes outside the iris 204. The sclera is quite consistent across ethnicities, with a slight yellow tint for darker skin tones such as individuals of black African heritage.

The '166 patent describes lighting adaptation operations comprising sampling different parts of the face to find an average skin color. In an embodiment, lighting adaptation operations also sample for average skin color but further make use or sclera evaluation with a goal to improving results while maintaining reasonable “costs” associated with computing device resource usage and processing time.

Input images may comprise an individual subject's face have occluded eyes, such as by hair or dark glasses. In an embodiment, in order to mitigate this issue, a pre-step, preformed by an Eye Coverage Detector, for example, comprises detecting if the eyes are covered. In such a case, sclera evaluation can be bypassed such that full lighting adaptation operations are not performed. In an embodiment, lighting adaptation such as described in the '169 patent, responsive to sample skin colors, can be performed.

### VTO Application

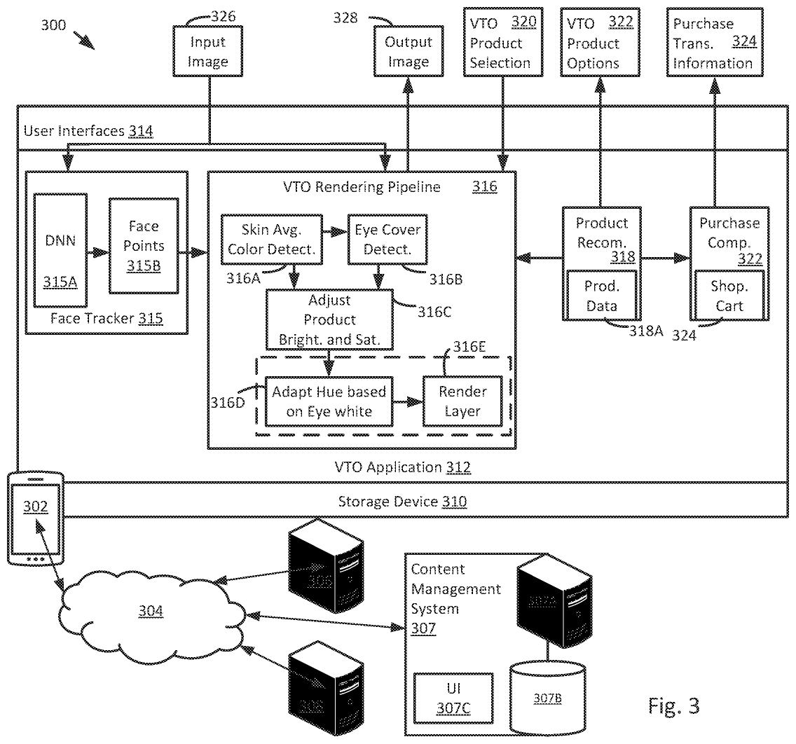

FIG. 3 is an illustration of a computing environment 300, in accordance with an embodiment, such as for practicing one or more method aspects. Computing environment 300 shows a user computing device 302, such as a smartphone, a communications network 304, a server 306 and a server 308. Communications network 304 comprises wired and/or wireless networks, which may be public or private and may include, for example the internet. Server 306 comprises a server computing device such as for providing a website. Server 308 comprises a server computing device such as for providing e-commerce transaction services. Though shown separately, the servers 306 and 308 can comprise one server device. Computing environment is simplified. For example, not shown are payment transaction gateways and other components such as for completing an e-commerce transaction.

Computing device 302 comprise a storage device 310 (e.g., a non-transient device such as a memory and/or solid state drive, etc.) for storing instructions that, when executed by a processor (not shown) such as a central processing unit (CPU), graphics processing unit (GPU) or both, cause the computing device 302 to perform operations such as a computer implemented method. Storage device 310 stores a virtual try on application 312 comprising components such as software modules providing, a user interface 314, face tracker 315 with a deep neural network (DNN) (e.g. a convolutional neural network (CNN)) face detector 315A providing face points 315B, a VTO rendering pipeline component 316, a product recommendation component 318 with product data 318A, and a purchasing component 322 with shopping cart 324 (e.g. purchase data). In an embodiment, not shown, the VTO application is without a recommendation component and/or a purchasing component, for example, providing a product selection component for selecting products to visualize as VTO effects.

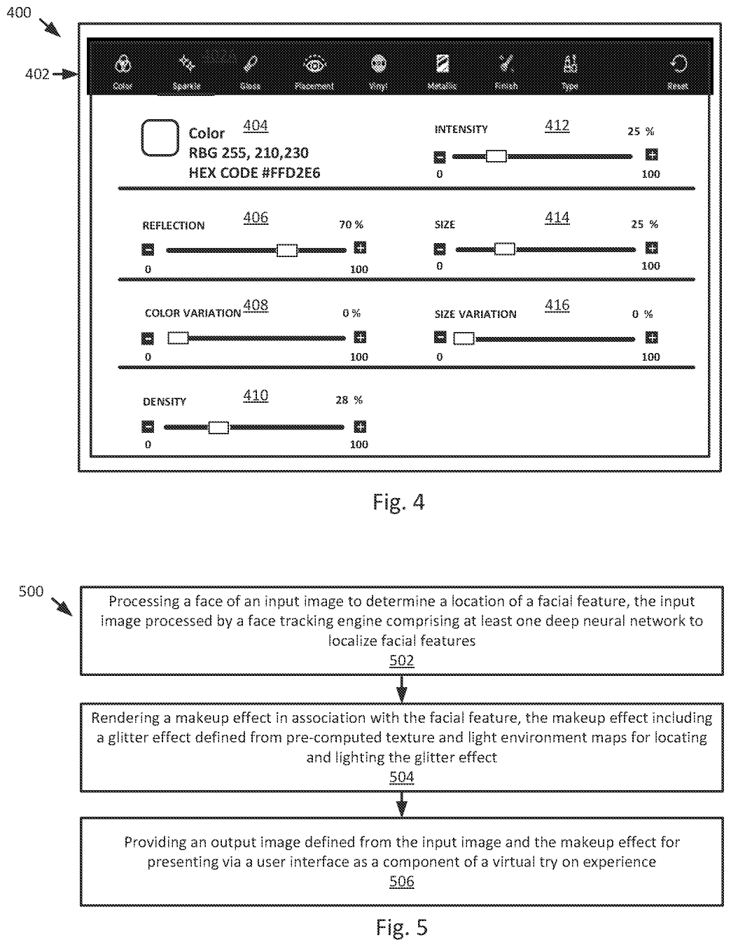

In an embodiment, VTO application is a web-based application such as is obtained from server 306. In an embodiment, the VTO application such as for a native application is provided by a content distribution network. Product data 318A can be obtained from a content management system 307, associated with server 307A. Content management system 307 includes a data store 307B storing product related data, for example, swatch data and rendering effects data, etc. Swatch data typically comprises an image of the product that can be used to illustrate the product. In an embodiment, swatch data (e.g. an image) may be processed to extract data therefrom. Swatch data, in the form of extracted data can comprise, for example, colour or other light-related properties (e.g., brightness, etc.) of the swatch data, etc. Product data (e.g. colour etc.) can be provided to a server in other manners such as in the form of colour or other parameters. For example, sliders can provide input that is mapped to data values. In an embodiment, product data can be provided to a user device (e.g. 302) by way of inclusion in a native application bundle and provided in the form of updates to a native application such as by server 306. Product data thus can be provided from different sources. Rendering effects data can comprise data for rendering an effect such as to simulate a makeup or other property such as a matte look, a gloss look, a metallic look, a vinyl look, or, as further described herein, a glitter look to the make up effect. A UI 307C to content management system 307 (e.g., see too, FIG. 4) can be provided to a provider of a product such as a brand owner, to upload swatch images and provide input such as for defining swatch data, product data and/or rendering effect data. In an embodiment, UI 307B is web-based.

Though not shown, user device 302 may store a web-browser for execution of web-based VTO application 312. In an embodiment (not shown), VTO application 312 is a native application in accordance with an operating system (also not shown) and software development requirements that may be imposed by a hardware manufacturer, for example, of the computing device 302. The native application can be configured for web-based communication or similar communications to servers 306, 307A and/or 308, as is known.

FIG. 3 shows various input and output data or information associated with a use of VTO application 312, for example. Such input and output data includes an input image 326 of the user to be processed for a VTO experience, an output image 328 to which product effects are simulated providing a VTO experience, a VTO product selection 320 comprising user input selecting one or more product effects to be simulated, VTO products options 322 comprising options for products to be virtually tried on, for example, for selection by a user of device 302, and purchase transaction information 324 comprising purchase information provided to and/or received from a user to purchase a product. As noted, not all VTO application embodiments include e-commerce capabilities.

In an embodiment, via one or more of user interfaces 314, VTO product options 322 are presented for selection to virtually try on by simulating effects on an input image 326. In an embodiment the VTO product options 322 are derived from or associated to product data 318A. In an embodiment, the product data can be obtained from server 306 and provided by the product recommendation component 318, which in an embodiment may be a product data parser where user-based recommendations per se are not made. Rather any available product data is made available for use selection. Though not shown, user or other input may be received for use to determine product recommendations. The user may be prompted, such as via one of interfaces 314 to provide input for determining product recommendations. In an embodiment, the product recommendation component 318 communicates with server 306. Server 306, in an embodiment, determines the recommendation based on input received via component 318 and provides product data accordingly. User interface 314 can present the VTO product choices, for example, updating the display of same responsive to the data received as the user browses or otherwise interacts with the user interface.

In an embodiment, the one or more user interfaces provide instructions and controls to obtain the input image 326, and VTO product selection input 320 such as an identification of one or more recommended VTO products to try on. In an embodiment, the input image 326 is a user's face image, which can be a still image or a frame from a video. In an embodiment, the input image 326 can be received from a camera (not shown) of device 302 or from a stored image (not shown). The input image 326 is provided to face tracker 315 such as for processing to localize features (e.g. objects) in the face image using the deep neural network 315A.

In an embodiment, location output from the face tracker 315 can comprise classification results, segmentation masks or other location data for one or more detected objects, and is provided to VTO rendering pipeline component 316. In an embodiment, localization output comprises face points 315B from the face tracker 315. The input image 326 is also provided (e.g. made available) to pipeline component 316. The VTO product selection 320 is also provided to pipeline component 316 for determining which effects are to be rendered. In an embodiment related to makeup simulation, one or more effects can be indicated such as for any one or more of the product categories comprising: lip, eye shadow, eyeliner, blush, etc.

VTO rendering pipeline component 316 renders effects on the input image 326 such as by drawing (rendering) effects in layers, one layer for each product effect, to produce output image 328. The rendering is in accordance with product data 318A as selected by VTO product selection 320 and is responsive to the location of detected objects. For example, a VTO product selection of a lipstick, lip gloss or other lip related product invokes the application of an effect to one or more detected mouth or lip-related objects at respective locations. Similarly a brow related product selection invokes the application of a selected product effect to the detected eye brow objects. Typically, for symmetrical looks, the same brow effects are applied to each brow, the same lip effect to each lip or the same eye effect to each eye region, but this need not be the case. Some VTO product selections comprise a selection of more than one product such as coordinated products for brows and eyes or other combinations of detected objects, which may be labelled as “product looks”. VTO rendering pipeline component 316 can render each effect, for example, one product effect per layer at a time until all effects are applied. The order of application can be defined by rules or in the selection of products e.g. lipstick before a top gloss.

User interfaces 314 provide the output image 328. Output image 328, in an embodiment, is presented as a portion of a live stream of successive output images (each an example 328) such as where a selfie video is augment to present an augmented reality experience. In an embodiment, output image 328 can be presented along with the input image 326, such as in a side by side display for comparison. In an embodiment, it can be a before/after “in place” comparison interface where the user move a slider to reveal more of the initial or processed image. In an embodiment, output image 328 can be saved (not shown) such as to storage device 310 and/or shared (not shown) with another computing device.

In an embodiment, (not shown) the input images comprise input images of a video conferencing session and the output images comprise a video that is shared with another participant (or more than one) of a video conferencing session. In an embodiment the VTO application (which may have another name) is a component or plug in of a video conferencing application (not shown) permitting the user of device 302 to wear makeup during a video conference with one or more other conference participants.

In the illustrated embodiment of FIG. 3, VTO rendering pipeline component 316 is configured to apply lighting adaptation to effects to be rendered. Components of VTO rendering pipeline component 316 are illustrated as a process flow showing, for example, operations (e.g., steps of a method) executed by one or more processors (e.g. CPU, GPU or both) of computing device 302. It is understood that corresponding modules or software component, for example, may implement such a flow. It is understood that other components for other adaptations that may be applied before rendering are not shown for simplicity.

In the embodiment and for at least some purposes, color is modeled using a hue, saturation and value/brightness (HSV or HSB) model. At 316A operations perform skin average color detection to determine an average skin tone color. In an embodiment, operations are performed in accordance with the '166 patent. For example, operations evaluate left and right skin (cheek), face skin (cheeks and forehead), left and right eye color, left and right eye sclera, min/max eyes brightness, and lips. At 316B operations perform eye cover detection, determining whether the eyes are covered such that the sclera is not available.

At 316C, operations adjust brightness and saturation of the product data for an effect to be applied to the input image responsive to the product selection 320. The brightness and saturation are adjusted in response to the skin average color and min/max eyes brightness as detected at 316A. If more than one product effect is to be applied, then step 316C is performed for each.

At 316D, the hue of the effect to be applied is adapted based on the eye white as detected from sclera in step 316A, if available, (where availability is detected at step 316B). In an embodiment operations determine whether the current color is shifted toward a warm tone or a cold tone. Operations interpolate between different H, S, and V based on the current color of the sclera. Thus, the hue of the effect is pushed towards a more warm tone or cold tone based on the detected conditions. To determine whether it is a warm or cold tone, the HSV values of the sclera are examined. An example of more detailed operations described further below.

At 316E, the product effect as adapted is rendered in a layer associated with input image 326 to define output image 328. In an embodiment such as when more than one effect is to be applied, steps 316D and 316E are repeated for each effect to be applied. Once steps of the pipeline component 316 are completed, the output image is provided such as via user interface 314.

In an embodiment, steps 316A-316C are performed by a central processor or CPU (not shown) while steps 316D and 316E are performed by a graphics processor or GPU (not shown), as denoted by the dotted line box.

The following is an example of more detailed operations regarding interpolation responsive to warm or cold tone of the sclera. The following inputs are used: cₛₖᵢₙ refers to the HSV color at the current skin pixel, with each HSV channel ranging in value from 0 to 1; c_{sclera} refers to the average HSV color at the sclera for the eye (either the left eye or right eye is used depending on which half of the face the current pixel resides in), with each HSV channel ranging in value from 0 to 1; and cₘₐₖₑᵤₚ refers to the HSV color for the target makeup colour, with each HSV channel ranging in value from 0 to 1.

A smoothstep(e₀,e₁, x) function is used throughout, which is defined as a function that smoothly interpolates between 0 to 1, beginning at x=e₀ and ending at x=e₁. An example implementation can be found at the time of filing at en.wikipedia.org/wiki/Smoothstep. Also used is rotationalMix(h₀, h₁, t) which is a function that linearly interpolates between hues h₀ and h₁ based on t. This function takes into consideration that the hue wraps around. For example, an interpolation between 0.9 and 0.1 with t=0.5 would produce 0.0 as output.

The following calculations are made to determine whether the skin is in a warm tone:

$${condition}_{skin \_ h \_ 1} = smoothstep ( 0.03 , 0 \text{.2} , {c}_{skin , h} )$$

$${condition}_{skin \_ h \_ 2} = 1. - smoothstep ( 0.3 , 0.35 , {c}_{skin , h} )$$

$${condition}_{skin \_ s} = smoothstep ( 0.3 , 0 \text{.4} , {c}_{skin , s} )$$

$${condition}_{skin \_ v} = smoothstep ( 0.3 , 1 \text{.5} , {c}_{skin , v} )$$

The following calculations are made to determine whether the sclera is in a warm tone:

$${condition}_{eye \_ h \_ 1} = smoothstep ( 0.06 , 0 \text{.7} , {c}_{sclera , h} )$$

$${condition}_{eye \_ h \_ 2} = 1. - smoothstep ( 0.4 , 0.45 , {c}_{sclera , h} )$$

$${condition}_{eye \_ s} = smoothstep ( 0.1 , 0.15 , {c}_{sclera , s} )$$

$${condition}_{eye \_ v} = smoothstep ( 0.6 , 0 \text{.7} , {c}_{sclera , v} )$$

To determine if the warm adjustment should be made, all the conditions are multiplied together, forming condition_{warm}. The adjustment is done using:

$${c}_{makeup , h , new} = rotationalMix ( {c}_{makeup , h} , 0.2 , {condition}_{warm} )$$

A similar process is applied for checking for a cold tone. The following calculations are made to determine whether the skin is in a cold tone:

$${condition}_{skin \_ h \_ 1} = smoothstep ( 0.5 , 0 \text{.8} , {c}_{skin , h} )$$

$${condition}_{skin \_ h \_ 2} = 1. - smoothstep ( 0.8 , 0.85 , {c}_{skin , h} )$$

$${condition}_{skin , s} = smoothstep ( 0.01 , 0 \text{.5} , {c}_{skin , s} )$$

$${condition}_{skin \_ v \_ 1} = smoothstep ( 0.6 , 0 \text{.7} , {c}_{skin , v} )$$

$${condition}_{skin \_ v \_ 2} = 1. - smoothstep ( 0.9 , 1 \text{.0} , {c}_{skin , v} )$$

The following calculations are made to determine whether the sclera is in a cold tone:

$${condition}_{eye \_ h \_ 1} = smoothstep ( 0.5 , 0.85 , {c}_{sclera , h} )$$

$${condition}_{eye \_ h \_ 2} = 1. - smoothstep ( 0.85 , 0 \text{.9} , {c}_{sclera , h} )$$

$${condition}_{eye \_ s} = smoothstep ( 0.1 , 0.15 , {c}_{sclera , s} )$$

$${condition}_{eye \_ v} = smoothstep ( 0.6 , 0 \text{.7} , {c}_{sclera , v} )$$

To determine if the cold adjustment should be made, all the conditions are multiplied together, forming condition_{cold}. The adjustment is done using:

$${c}_{makeup , h , new} = rotationalMix ( {c}_{makeup , h} , 0.75 , {condition}_{cold} )$$

In a method aspect, there is provided the following hue related embodiments: Hue Embodiment 1: A computer implemented method comprising executing by one or more processors the steps of: processing a sclera in a face of an input image to determine a reference hue of the face; adjusting a hue of a makeup effect in response to the reference hue to render an adjusted makeup effect to the input image; and presenting an output image defined from the input image and the adjusted makeup effect via a user interface as a component of a virtual try on experience.

Hue Embodiment 2: In Hue Embodiment 1, the hue of the makeup effect is pushed towards a more warm tone or a more cold tone responsive to the reference hue.

Hue Embodiment 3: In Hue Embodiment 1 or 2, the processing adjusts a brightness and a saturation of the makeup effect in response to an average skin color determined by processing skin in the face and responsive to eye brightness (e.g. min/max) determined by processing one or more eyes in the face.

Hue Embodiment 4: In any of the Hue Embodiments 1 to 3, adjusting the hue is responsive to detecting a presence of the sclera for adjusting the hue. For example, the hue is not adjusted if the sclera is not present. Brightness and saturation can still be adjusted.

Hue Embodiment 5: In any of the Hue Embodiments 1 to 4, the method comprises processing the image using a deep neural network to localize facial features in the face; and wherein the sclera is process and the makeup effect is rendered in response to the facial features as localized.

Hue Embodiment 6: In any one of Hue Embodiments 1 to 5, the makeup effect is associated with a makeup product and the method comprises providing, via the user interface, a recommendation of a plurality of makeup products to virtually try on; and receiving a selection input, via the user interface, selecting the makeup product for the virtual try on experience.

Hue Embodiment 7: In Hue embodiment 6, the selection input selects a plurality of products and the method comprises adjusting the hue of each associated makeup effect in response to the reference hue for rendering a plurality of adjusted make effects to the input image.

Hue Embodiment 8: In any of the Hue Embodiments 1 to 7, the method comprises providing, via the user interface, a purchase service to conduct an purchase transaction (e.g. via e-commerce) to purchase one or more makeup products.

It will be appreciated that a system aspect and a computer program product aspect are each disclosed corresponding to each one of Hue Embodiments 1 to 8.

For example in a system aspect there is provided the following hue related embodiment: Hue Embodiment 9: A system comprising a rendering pipeline configured (e.g. via circuitry) to: process a sclera in a face of an input image to determine a reference hue of the face; adjust a hue of a makeup effect in response to the reference hue to render an adjusted makeup effect to the input image; and provide an output image defined from the input image and the adjusted makeup effect for presenting via a user interface as a component of a virtual try on experience.

Makeup Effect with Glitter

Glitters are used in many different makeup products, such as eyeshadow, lipstick, but also blush or eyeliner. Glitters typically require many input variables and computations to calculate realistic reflections such that the simulation of the effect is difficult to perform correctly.

At the heart of any glitter effect is the computation of a set of particles that will be spread across the surface where the particles should shine. Computing a position and reflection (e.g., a particle property) for each particle, represented in a texture map, may require too much computational power to be run in live mode on a mobile device.

In accordance with an embodiment, such as to off-load the computation during live mode rendering, texture maps (position, and particle properties) are pre-generated before the rendering occurs. The texture maps can be reused during rendering of a product with glitter.

In accordance with techniques and empirical values herein, the pre-generated textures provide improved glitter effects when used in real time.

Particle Texture: The first step is to compute a particle texture that will serve to position the particle and store the properties of each particle (e.g. size, reflectance, base color, orientation, etc.) In an embodiment, the texture is calculated using a Voronoi Diagram (structure). An example of a Voronoi Diagram is found at en.wikipedia.org/wiki/Voronoi_diagram.

The Voronoi texture has certain properties that make it useful for defining glitter particles for rendering. A Voronoi texture is created by generating random 2D points and creating boundaries in between the points, where the boundaries have equal distance to the nearest points. These Voronoi regions formed from the boundaries define the glitter particles' positions. It was determined that the manner of generating the random 2D points can have a perceptible effect. In an embodiment, the random 2d points are generated in accordance with a Poisson disk sampling technique. Poisson disk sampling produces more evenly distributed samples in an image than uniform sampling. A discussion and examples are found in the article, “Visualizing Algorithms”, Bostock, M., Jun. 26, 2014 available at the time of filing at bost.ocks.org/mike/algorithms, and incorporated herein by reference.

In an embodiment, for example, relative to a product swatch image, there are two texture images (maps) used to store particle information. One stores the normals of the particles, and the other stores the centers of the particles. The normals are normalized vectors with their angles to the +z direction randomly sampled (e.g. using Poisson disk) over an empirically-determined hard-coded range. The centers of the particles are coordinates normalized by the dimensions of the image. The texture maps define the glitter particles with location in a 3D space e.g. using a particle centre and a normal vector. In an embodiment, the normal vector is a 3D direction, and comprises x, y, z values (where the x, y values are different from pixel or other grid related (x,y) locations of the particle centre).

These textures are sampled at a certain size dependent on the glitter size parameter in a product, and they are configured to be sampled on repeat across borders. In an embodiment, the textures are sampled using mipmapping, where different resolutions of the textures are pre-generated. Mipmapping is a graphics technique which scales an original, high-resolution texture image or map and filter, and scales it into multiple smaller-resolution texture maps. During rendering, operations dynamically pick which texture to use based on various factors, such as the output resolution relative to the glitter texture size. And the texture is scaled based on the glitter size.

### Environment Mapping

A pre-generated environment map is used to define the lighting of an environment in accordance with an image based lighting (IBL) technique. It is found that instead of using a real life environment map, a control of how ‘sparkly’ the glitter is achieved by generating the environment map as if there is a spot light from a certain direction and concentric rings of light around the central spot. Note that this environment map only needs to be grayscale as only brightness of the environment and not the colors is of concern. In an embodiment, the environment map is stored as a cubemap (e.g. 6 textures that can be wrapped/folded to define a cube) with each cube face vertically stacked into one image. Each cube face is how the spotlight from a certain direction would appear if one was to view the light from the particular face.

### Glitter Rendering

To render the glitter effect, operations find a normal of the glitter particle, which may be transformed by the rotations of the face and surface (if provided). In an embodiment, a face tracker engine, for example, can provide object localization information such as for eyes, lips, and/or face contour—e.g. face points. The points (localization information) can be used to determine a rotation of the face (e.g. relative to a standard). A 3D or other model can give additional surface information, for example, about a surface of the region where the glitter is to be applied. 3D shape information is described further herein.

In an embodiment, rendering is applied using physical based rendering (PBR) and image based lighting (IBL) techniques. Physical based rendering material properties (e.g. roughness, F0, etc.) and the view direction are hard-coded (e.g. pre-computed and stored), while the brightness of the environment is found from the environment map (cubemap and its texels) using the normal vector. These data are used in PBR's image based lighting calculation to find the specular brightness of the particle such as described in Learn OpenGL—Graphics Programming “Specular-IBL”, de Vries, Joey, Jun. 17, 2020 available at the time of filing at learnopengl.com/PBR/IBL/Specular-IBL, and incorporated herein by reference. Note that, in an embodiment, a diffuse term (one of the IBL elements) is ignored, as the particle is expected to be mostly reflecting.

As noted herein, a makeup effect simulates application of a product to a portion of a face such as lipstick to lips, eyeshadow to an eyelid region about an eye, etc. The portion of the face having the effect is overlaid on an input image, such as by a GPU. Thus the portion/effect comprises pixel data that is to be determined for the overlay operation such as using the texture map, environment map and rendering data, etc. Pixels of the effect then can be considered to represent glitter particles and non-glitter particles. Whether a particular pixel, e.g. a current pixel is or is not a glitter particle pixel can be determined using various parameters such as the distance to a center of a glitter particle (within the texture map) and the size of the particular glitter particle. The center of the particular glitter particle can act as a seed for determining particle parameters such as a particle's size (e.g. in a number generator that determines size in a normalized range) or color (e.g. e.g. in a number generator that determines values within a range of a color model).

In an embodiment, glitter particles are circular and the size distance to the center is used to draw the circular shape of the particle and the glow alpha (only the center part of fully lights and the light fades out towards the edge of the particle).

Combining the results of these calculations, the lighting up of the particle is rendered.

One limitation of a Voronoi texture is that it doesn't allow overlapping. In an embodiment, to have the glittering effect appear at higher density and have overlapping of particles, as, rendering operations are repeated where the texture map is used to define a plurality of overlapping texture map layers. Operations repeat and overlay the glitter rendering with the particle textures (i.e. the texture map) rotated by 90, 180, and 270 degrees. In an embodiment, operations vary the density by assigning an existence probability of a particular glitter particle in the texture map to a layer, and whether a particle exists will depend on a random value that is greater or less than the existence probability. I.e. if the existence probability of a layer is 0.8, and the value of a particle is 0.6, then it will exist, but if its value is 0.9, then it doesn't exist (its glow alpha set to 0, for example).

FIG. 4 is a screenshot of a UI 400 for glitter parameters settings, for example, for defining rendering effect data. UI 400 can be made available to a brand owner or other entity to define characteristics for a makeup effect such as for a VTO experience. The UI can be configured to receive product data such as to define the underlying makeup effect as well as any special rendering effects such as special lighting or glitter effects, makeup effect shapes (e.g. mask images), etc. In an embodiment, UI 400 is an example of a UI 307B.

UI 400 is useful for tuning a glitter effect (e.g., a glitter look or “sparkle”) such as provided by a sparkle/glitter particle of a makeup effect. An example makeup effect is an eye effect such as provided by an eye shadow, a lip effect such as provided by a lipstick, a cheek effect such as provided by a face powder, etc.

UI 400 comprises a ribbon of icons 402 such as for switching user interfaces (others not shown) for each of different products, product effects and/or associated looks. Icon 402A relates to glitter (“sparkle”) and invokes UI 400. UI 400 comprises a plurality of input controls (e.g. 404-416) for receiving input to define respective glitter look properties/parameters. Controls 404-416 can take various forms and a plurality herein comprise slider controls. Other types of input controls for input of text or similar values are known and useful. Voice activated controls can be used. Controls 404-416 comprise:
Color 404: Base color of the glitter (will be altered by the reflection, intensity and color variation); invoking color control 404 can present a further color section control (not shown) such as a color wheel and/or Red, Green and Blue (RGB) input value control for defining a color using RGB additive color values.

Reflection 406: How much the glitter are reflective;
Color Variation 408: 0 means no variation 100% means variation over all of the color spectrum;
Density 410: how much sparkles do we spawn;
Intensity 412: the amount the sparkles are visible;
Size 414: base size of the sparkle (can be altered by the size variation); and
Size variation 416: 0 mean no variation, 100% means that all glitter particles vary in size (e.g. within a normalized range).

Thus in an embodiment, rendering operations first render a base product (e.g. in a shape applied to region of the face associated with one or more facial features. Then rendering operations render one or more, preferably a plurality of glitter layers of glitter particles are applied on top (e.g. 4 layers in total). Multiple layers are preferably used in order to allow particles to overlap. For a random size of a glitter particle in a layer of glitter particles, rendering operations generate a random size between a hardcoded min and max value (which are affected by the glitter size), and linearly interpolate between base glitter size and the random size based on a parameter called “glitter size variation”. If this parameter is zero, there is no randomness, and if it's one the size is completely random. For a random colour of the glitter particle, operations generate a random colour within a certain Hue Saturation and Lightness (HSL) range (e.g. in an embodiment, limited to only colours that have a high saturation and high lightness). Similar to the glitter size, operations linearly interpolate between the base glitter colour and the random colour based on a parameter called “glitter colour variation”. If this parameter is zero, there is no randomness, and if it's one the colour is completely random. Pixel values of the glitter makeup effect are assigned responsive to distance to a glitter particle centre. If a current pixel's distance to a center is within the circle size, the current pixel is treated as a glitter pixel, otherwise nothing is changed for that pixel (as the base product has already been rendered). Since each pixel of the pre-generated texture map contains the center for the nearest particle, it only needs to do one texture lookup for the current pixel to determine the nearest particle.

FIG. 5 is a flowchart of operations 500, in accordance with an embodiment, such as for a computing device of FIG. 3 (e.g. device 302). The operations 500 define a computer implemented method comprising executing by one or more processors the steps of a method. For example, in a method aspect, there is provided the following glitter related embodiments:

Glitter Embodiment 1: A computer implemented method comprises executing by one or more processors the steps of: processing a face of an input image to determine a location of a facial feature, the input image processed by a face tracking engine comprising at least one deep neural network to localize facial features (step 502); rendering a makeup effect in association with the facial feature, the makeup effect including a glitter effect defined from pre-computed texture and light environment maps for locating and lighting the glitter effect (step 504); and providing an output image defined from the input image and the makeup effect for presenting via a user interface as a component of a virtual try on experience (step 506). The face tracking engine may comprise the face tracker 315 as previously described, for example. Rendering (and providing the output image) can be provided by the rendering pipeline 316 as adapted for the glitter effect teachings herein, for example.

Glitter Embodiment 2: In Glitter Embodiment 1, the makeup effect comprises a lip makeup effect, an eye region makeup effect, or a cheek region makeup.

Glitter Embodiment 3: In Glitter Embodiment 1 or Glitter Embodiment 2, the step of rendering is responsive to physical based rendering techniques to define the glitter effect.

Glitter Embodiment 4: In any of Glitter Embodiments 1 to 3: a pre-computed texture map defines, for each of a plurality of glitter particles, a glitter location and a glitter reflectance angle; a light environment map simulates a light source (e.g., in a three dimensional space) for determining a specular brightness of a particular glitter particle in accordance with the reflectance angle of the particular glitter particle; and the rendering defines pixel values for pixels of the makeup effect, adjusting a lighting up of a current pixel in accordance with a distance of the current pixel to a glitter location of a particular particle, the specular brightness of the particular glitter particle, and a size of the particular glitter particle. Glitter Embodiment 5: In Glitter Embodiment 4, the specular brilliance is further determined in response to a three dimensional shape of the makeup effect and a rotation of the face.

Glitter Embodiment 6: In Glitter Embodiment 4 or 5, a size of the particular glitter particle is randomly assigned within a normalized range.

Glitter Embodiment 7: In any of Glitter Embodiments 4 to 6, the lighting up is further responsive to a glow alpha of the particular glitter particle, defining a light fade from a center.

Glitter Embodiment 8: In any or Glitter Embodiments 4 to 7, the rendering further colours the makeup effect responsive to a glitter colour of the particular glitter particle.

Glitter Embodiment 9: In any or Glitter Embodiments 4 to 8, the plurality of glitter particles are randomly spaced in the texture map without overlapping and wherein the rendering repeats the defining of the pixel values using the texture map in a plurality of overlapping texture map layers to overlap glitter particles in the glitter effect.

Glitter Embodiment 10: In Glitter Embodiment 9, the rendering varies a glitter particle density of the glitter effect, randomly determining whether a particular particle in the texture map exists in any one of the overlapping texture map layers.

Glitter Embodiment 11: In any one of Glitter Embodiments 4 to 10, a normal to the reflectance angle (e.g. defined as a vector) is used with the light environment map for determining spectral brilliance.

Glitter Embodiment 12: In any one of Glitter Embodiments 4 to 11, each of the glitter locations of the plurality of glitter particles are randomly assigned using Poisson disk sampling.

Glitter Embodiment 13: In any one of Glitter Embodiments 1 to 12, rendering is responsive to any one or more rendering effects parameters comprising color, reflection, color variation, density, intensity, size, and size variation parameters.

It will be appreciated that a system aspect and a computer program product aspect are each disclosed corresponding to each one of Glitter Embodiments 1 to 13.

A further glitter related method aspect is disclosed such as for a computing device configured to pre-compute maps for use during a rendering. For example, there is provided Glitter Embodiment 14: A computer implemented method comprises executing by one or more processors the steps of: pre-computing texture and light environment maps for locating and lighting a glitter effect as a component of a makeup effect to be rendered in association with a facial feature localized by a face tracking engine of a make-up virtual try on application; and providing the pre-computed texture and light environment maps for use by a rendering pipeline of the make-up virtual try on application for rendering the makeup effect having the glitter effect. Glitter Embodiment 15: In Glitter Embodiment 14, the pre-computed texture and light environment maps are defined for generating the glitter effect in accordance with physical based rendering techniques that model the particles in a lit environment. Glitter Embodiment 16: In Glitter Embodiment 14 or 15, a texture map is precomputed in accordance with a Voronoi Diagram technique, providing random locations for a plurality of glitter particles about the glitter effect, and the texture map is further computed to comprise respectively a reflectance angle for each of the plurality of glitter particles. Glitter Embodiment 17: In Glitter Embodiment 16, the light environment map is defined to model a source of light, such that at a time of rendering, a specular brilliance is provided respectively for each of the plurality of glitter particles in the glitter effect, the specular brilliance responsive to the reflectance angle. Glitter Embodiment 18: in Glitter Embodiment 16 or 16 the locations of the glitter particles are assigned using Poisson disk sampling distribution.

It will be appreciated that additional method related embodiments adapted as may be applicable from any of Glitter Embodiments 1 to 13 can apply to Glitter Embodiments 14 to 18. It will be appreciated that a system aspect and a computer program product aspect are each disclosed corresponding to each one of Glitter Embodiments 14 to 18 or as adapted as noted. Any of the Glitter Embodiments can be combined with any one or more of the Hue Embodiments, Shaping Embodiments and Mesh Embodiments, for example, combining method aspects thereof, defining corresponding system aspects, etc.

### Shaping a Facial Feature

Typically, makeup VTO applies a product effect to a facial feature as that feature is identified by a face tracker engine, such as face tracker 315. The VTO typically only uses the original image and applies a “painting” color or texture on top to cover the original colors of the detected facial feature like a normal makeup would do. However for the brow category some of the beauty products sold include shaping tools and products that allow a user thereof to change the overall or local shape of the brow. Simulating the reshaping is desired. In addition to detecting and rendering to the detected shape, an additional set of transformations can be employed such as described herein to reshape, for example to perform brow warping.

In an embodiment, brow warping is an image manipulation technique which transforms the pixels of the original image. Pixel transformation is preferred over replacing the original brow with a synthetic one. Removing and replacing with an overly can be difficult and provide results that are not sufficiently realistic.

Some examples of brow transformations comprise: global arch raise, inner thickness decrease or increase, top cleaning, and bottom cleaning. Brow shapes can be characterized as having an inner part nearer the nose, a middle part and an outer part, furthest from the nose. The inner, middle and outer part are located along or define a brow arch having a top line (nearest the forehead), and a bottom line (nearest the eye).

In an embodiment, values of the brow that can be transformed (e.g. brow parameters) comprise: Outer part: horizontal and vertical align, thickness; Inner part: horizontal and vertical align, thickness; Arch: local and global increase/decrease, pointiness of the arch; Middle part: thickness; Cleaning: top, bottom, inner part; and Global: horizontal and vertical shift.

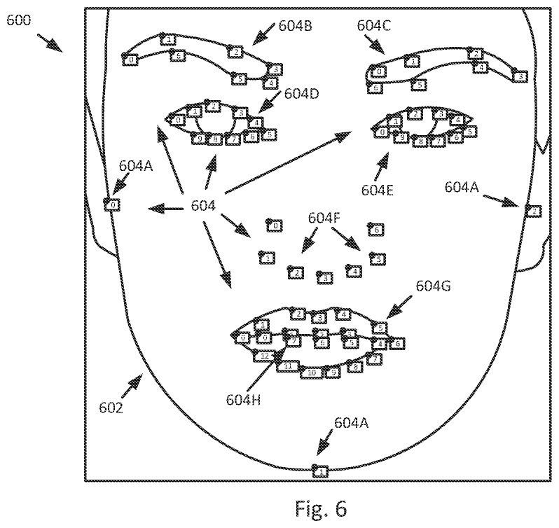

In an embodiment, a face tracker, such as tracker 315, can localize facial features and provide face points such as depicted in FIG. 6. FIG. 6 shows an example of a face image 600 (e.g. a cropped image of a face 602) annotated with groups 604 of face points. The depiction of points on the face is for purposes of illustration. Output of face tracker 315 need not comprise an annotated image and the output of face points and a cropped face, for example, can be separate data or the cropped face not provided per se.

In an embodiment, the groups 604 of face points comprise face contour face points 604A, respective right and left eyebrow face points 604B, 604C, left and right eye face points 604D and 604E, nose face points 604F, and two lip face points 604G and 604H. In an embodiment, the lip face points comprise an outer lip group 604G (around the mouth) and an inner lip group (between the lips) 604H. The face points in an individual group are numbered (e.g. 0, 1, 2, . . . ) and assist with defining the contour of the detected object. In an embodiment, the face tracker assigns each point so that it is placed at consistent locations relative to the contour of the object it is denoting. For example, a particular point might always be at a right corner of the mouth. In an example, the face points are X,Y pixel coordinates, relative to the cropped face image 602 and are associated with respective detected objects from (e.g. one of) the networks of tracker 315.

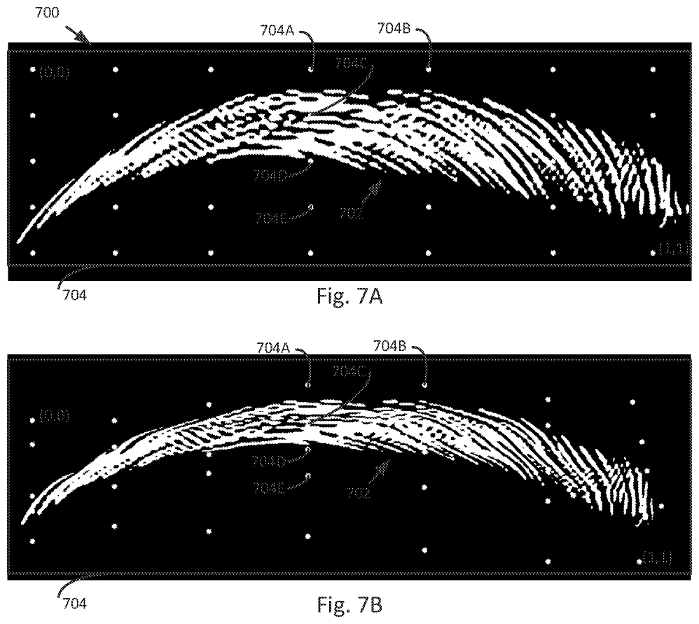

In an embodiment, operations such as for face tracker and rendering pipeline components of a virtual try on application perform a computer implemented method comprising one or more steps as follows:
1. Process an input image using the face detector providing one or more neural networks to localize facial features to obtain eye and brow face points.
2. FIGS. 7A and 7B are illustrations of a face warping construct 700, in accordance with an embodiment, to warp a brow (an example of a facial feature). As depicted in FIG. 7A, on each brow (e.g., left brow 702), define a rectangular warping grid (704) that is centered on each brow region. The size of this box (grid) is calculated from the sizes and distances of various facial features. The grid is also rotated (via affine transforms) to match the rotation of the face. For example, using the face contour face points 604A, face rotation can be determined relative to a standard position. A coordinate system (e.g., as represented by points in the grid box 704) is defined within the grid, with coordinates ranging from (0, 0) to (1, 1). This simplifies warping calculations as they no longer need to worry about the rotation of the face or the size of the brows. The brow face point group and eye face point group for a right eye or a left eye is mapped into this coordinate system (into respective grids determined for each of these pairs of facial features), for use during deformation calculations.
3. The warping grid is discretized into a grid of 2D points (e.g. the illustrated points in the box 704 including points 704A, 704B, 704C, 704D and 704E, where 704C is located within brow 702 between points 704A and 704D). By moving a grid point (e.g. 704D), the face image pixel at or near that grid point and its surrounding pixels (e.g., near grid point 704E, for example) are moved as well. See FIG. 7B for movement of grid points and resulting movement of brow pixels to reshape the brow 702. Linear interpolation of the warping is performed in between points. In an embodiment, a GPU provides this linear interpolation as a built in function. A trade-off exists in which choosing a denser grid results in smoother deformations but higher (GPU) processing time. Such as through experimentation, it was found that a 25 by 50 point grid (1,250 points in total) provides a good balance between quality and speed for GPUs provided for commonly available mobile devices at the time of filing such as smartphones. Anything higher gave diminishing returns in quality. With more powerful hardware, a denser grid could be used.
4. Each point on the grid is then warped, with the warping calculated using the applicable face points and warping parameters. That is, predefined grid point warps (movements) can be defined in association with particular brow transformations (e.g. parameters).
5. The facial image (e.g. its pixels) is then warped based on the warping grids. For example, brow shaping shapes both brows, each having a grid. Brow shaping can be performed with other beauty filter shaping such as eye or lid shaping, lip shaping, nose bridge shaping, nostril shaping, face contour shaping (e.g. jaw slimming), etc., where each feature being shaped has a respective grid.

### Warping Calculations

The warping calculations used for each brow parameter are different, but there are some shared techniques among them. Each parameter has an associated warping function:

$${p}_{out} = {f}_{param} ( {p}_{in} , {p}_{brows} , {p}_{eyes} , {v}_{param} )$$

where: ρᵢₙ is the input grid point,
ρ_{brows} is the set of brow points,
ρ_{eyes} is the set of eye points, an example of an associated facial feature and useful to define an eye region facial feature (e.g. an associated facial feature) between the brow and the eye points along an upper curve of the eye; Initially, the set of eye points and brow points are provided by the face tracker.
νₚₐᵣₐₘ is the value for that parameter,
ρₒᵤₜ is the output grid point.

In an embodiment, warping is performed by iteratively applying each warping function (e.g. each where a shape parameter (param) denotes a change to the brow) on the warping grid. The overall process is:

For each parameter param:

Warp the grid by applying fₚₐᵣₐₘ to each grid point;

Apply fₚₐᵣₐₘ to ρ_{brows} and ρ_{eyes} in order to obtain a new set of brow points ρ′_{brows} (and eye points ρ′_{eyes}), since the brow points (and eye points may) have changed due to the warping. Use the new points for the next iteration.

Though not shown, a user interface, for example similar to user interface 400 can be provided to receive input for brow parameters. In an embodiment, slider or other controls can be provided to input how much change is to be made to a parameter.

### Warping Techniques

There are some techniques that are common among the warping functions. This section lists out those techniques:

Curve matching: A curve is calculated for the current brow (by fitting a curve along the middle of the brow, using the brow points of the face tracker), and a target curve is calculated from the parameters. This is useful for changing the overall curvature of the brow. The brow is deformed (e.g. in the grid) such that the current curve is warped to match the target curve. This is done by matching the points on the source curve with the target curve, and warping based on the delta. For points away from the curve in the grid, a 2D Gaussian attenuation function is applied so that points close to the curve are more strongly warped than points further away. The ax and ay of this Gaussian function can be changed to adjust the “area of affect”. For example, ay needs to be large enough that it affects the entire thickness of the brow. In some cases, the Gaussian function can be replaced with a different function, for example an asymmetrical version of the Gaussian function or one that has a “shorter tail” or “longer tail”.

Point matching: This is similar to curve matching except instead of matching some curves, some discrete points are being matched instead. This is useful for cases such as adjusting the alignment of a specific portion of the brow.

Area expansion/compression: The surrounding area along a curve or at a point can be “compressed” or “expanded” (either in a specific direction such as vertically, or uniformly). This is done by bringing nearby points closer/further, attenuated with a Gaussian function. This is useful for operations such as changing the brow thickness or brow edge sharpening.

Implementation: The warping grid is rendered by using the grid points as vertices, such as to define a polygon mesh. Triangles are fit onto the vertices and the image is UV mapped onto the vertices. UV mapping in the embodiment is a 2D modeling process of projecting a 2D model's surface to a 2D image for texture mapping. The letters “U” and “V” denote the axes of the 2D texture.

Beauty Filters: In a similar manner for operations to perform brow warping, beauty filter operations are a set of transformations that change the shape of other facial features. In an embodiment, transformations comprise: Eye enlargement (vertically and horizontally); Jaw slimming; Nostril slimming; and Nose bridge slimming. An implementation for beauty filters is the same as for the brow filters but the regions affected are different, as applicable.

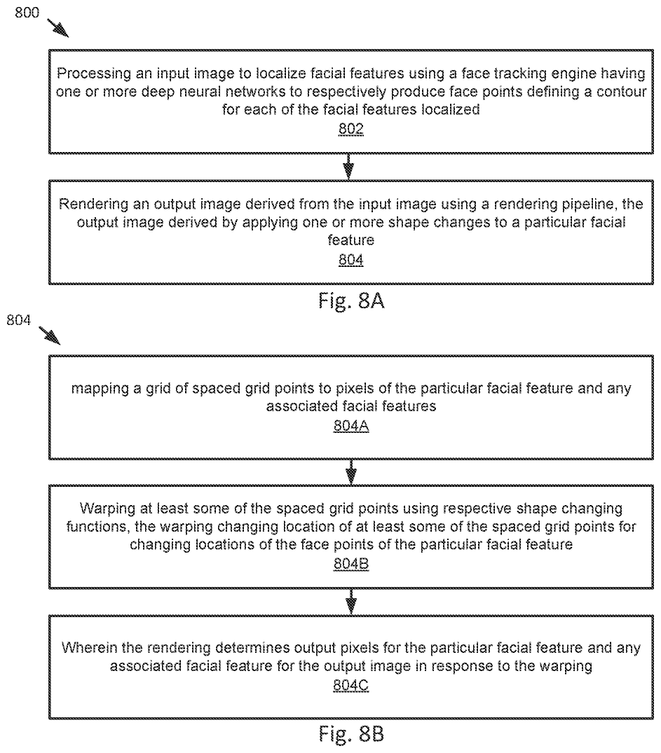

FIG. 8A are 8B are a flowchart of operations 800 and 804 such as for a computing device of FIG. 3 (e.g. device 302) in accordance with an embodiment. The operations 800 define a computer implemented method comprising executing by one or more processors the steps of a method. The operations 804 are further defined as steps 804A-804C, in an embodiment.

For example, in a method aspect, there is provided the following shaping related embodiments: Shaping Embodiment 1: A computer implemented method comprises executing by one or more processors the steps of: processing an input image to localize facial features using a face tracking engine having one or more deep neural networks to respectively produce face points defining a contour for each of the facial features localized (step 802); and rendering an output image derived from the input image using a rendering pipeline, the output image derived by applying one or more shape changes to a particular facial feature (step 804), the one or more shape changes determined by: i) mapping a grid of spaced grid points to pixels of the particular facial feature and any associated facial features (804A); and ii) warping at least some of the spaced grid points using respective shape changing functions, the warping changing location of at least some of the spaced grid points for changing locations of the face points of the particular facial feature (804B); and wherein the rendering determines output pixels for the particular facial feature and any associated facial feature for the output image in response to the warping (804C).

The face tracking engine may comprise the face tracker 315 as previously described, for example. Rendering (and providing the output image) can be provided by the rendering pipeline 316 as adapted for the glitter effect teachings herein, for example. Shaping Embodiment 2: In Shaping Embodiment 1, the face tracking engine and rendering pipeline are components of a VTO application for simulating the effects of a makeup product applied to facial features. Shaping Embodiment 3: In Shaping Embodiment 2, the rendering pipeline renders a makeup effect to the particular facial feature as shape changed such that the output image comprises the particular facial feature as shaped changed and with the makeup effect.

Shaping Embodiment 4: In any of Shaping Embodiments 1 to 3, the method comprises providing a user interface to receive input to define shape parameters for the one or more shape changes and wherein the rendering is responsive to the user input.

Shaping Embodiment 5: In Shaping Embodiment 4, at least some of the shape changing functions perform one or more of: curve matching to match a middle curve along a middle of the contour of the particular facial feature with a target curve defined by the shape parameters of the one or more shape changes, attenuating location changes to spaced grid points responsive to distance to the target curve; point matching to match a discrete point of the contour of the particular facial feature to a target point defined by the shape parameters of the one or more shape changes; and area expansion or area compression to expand or compress an area along a face point curve or about a particular pixel, responsive to the shape parameters, the area expansion or area compression attenuated by an attenuation function responsive to distance from the face point curve or the particular pixel.

Shaping Embodiment 6: In any of Shaping Embodiments 1 to 5, determining the pixels comprises fitting triangles to vertices defined by the spaced grid points as warped and UV mapping the pixels of the particular facial feature and any associated feature onto the vertices.

Shaping embedment 7: in any one of Shaping Embodiments 1 to 6, the particular facial feature defines a first facial feature and the step of rendering is repeated in respect of a second facial feature to product an output image having at least two shape changed facial features.

Shaping Embodiment 8: In any of Shaping Embodiments 1 to 7, the shape changes applied to the particular facial feature comprise any one of a brow shaping, a nose shaping, such as a nostril slimming or a bridge slimming, a face contour change, such as jaw slimming, an eye or eyelid change such as a vertical or a horizontal eye enlargement; or a lip change such as lip plumping.

It will be appreciated that a system aspect and a computer program product aspect are each disclosed corresponding to each one of Shaping Embodiments 1 to 7, for example. Any of the Shaping embodiments can be combined with any one or more of the Hue Embodiments, the Glitter Embodiments and the Mesh Embodiments as noted.

3D Mesh from 2D Landmark

In an embodiment, to facilitate more realistic facial feature rendering, whether for applying a shaping effect or for applying a makeup effect (such as makeup looks), rendering operations (e.g. of pipeline 316) can be configured to utilize 3D polygon meshes. In an embodiment, 3D polygon meshes are used for rendering special lighting effects (e.g., metallic, vinyl) to a makeup effect.

A mesh is a collection of vertices, edges and faces that define (e.g., model) the shape of a 3D object. There are many advantages of using polygon meshes in addition to being able to actualize complex lighting effects: polygon meshes can be efficiently rendered since many commercially available GPUs used in consumer smartphones tablets, etc. at the time of filing are optimized to handle polygons, thus leading to a faster rendering speed.

In a VTO application, user input can indicate which product or products are to be applied as one or more makeup effects associated with at least some of the facial features localized by a face tracker. An effect can be applied to an image using a mask (e.g. a 2D mask image) providing a shape to the makeup effect at a location relative to the at least some of the facial features. For example, to provide realistic effects that are responsive to 3D shapes of the facial features, a mask for an effect can be warped to realistically fit a 3D mesh model of the facial features. The warped 2D mask image can be UV mapped for used to shape the effect during rendering.

### Generate 3D Mesh

In an embodiment face tracker 315 detects 2D face points. Rendering operations generate 3D meshes using the 2D face points. In an embodiment operations to generating a 3D mesh comprise:
1. Estimate 3D face points using detected 2D face points and an existing 3D face model—project 2D face points onto 3D space to get 3D face points. Normally cameras and human eyes see in perspective projection. When a 3D point is projected into 2D space, a perspective projection matrix is applied. In an embodiment, to go from a 2D point to a 3D point, the inverse of the projection matrix can be applied. However, the depth is unknown, so the result is actually a 3D ray rather than a 3D point. To obtain a 3D point, operations approximate the face with a 3D plane and intersect the 3D ray with the plane to get a 3D point. An hardcoded offset is added to each point to account for the fact that the face is not actually flat. For example, for the lip points, the points near the corners of the mouth would be further in depth from the camera than points at the center;
2. Interpolate spline curves using the 3D face points, and use these smoothed curves as the contours of facial features;
3. Generate a 3D grid (e.g. of spaced grid points), and deform the grid points to fit the curvature of the 3D contour lines; and
4. Extract 3D facets (in triangular shape) from the deformed grid and group them together to form the 3D facial mesh.

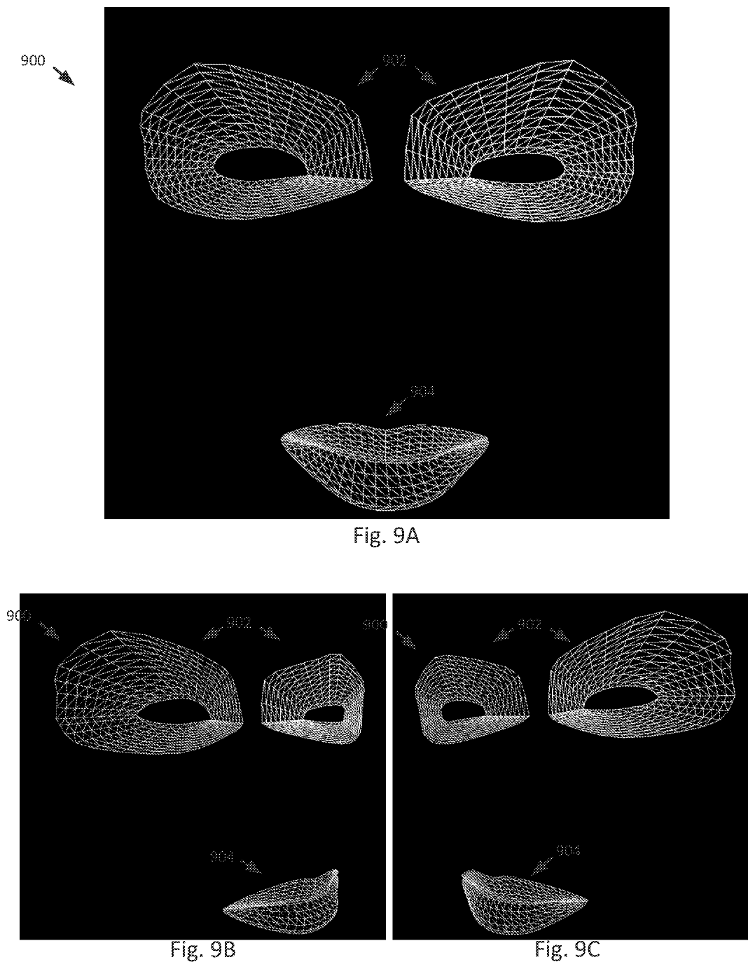

FIGS. 9A, 9B and 9C are illustrations of 3D polygon meshes 900 comprising eye meshes 902 and lip mesh 904 for eye and lip related facial features, in accordance with an embodiment. FIG. 9A shows a front view while FIGS. 9B and 9C show partially turned left and right views. FIG. 9A is enlarged relative to FIGS. 9B and 9C for convenience. It is apparent that eye related meshes in the present embodiment include regions around a respective eye, including the associated brow.

Map 2D Mask Image onto 3D Mesh

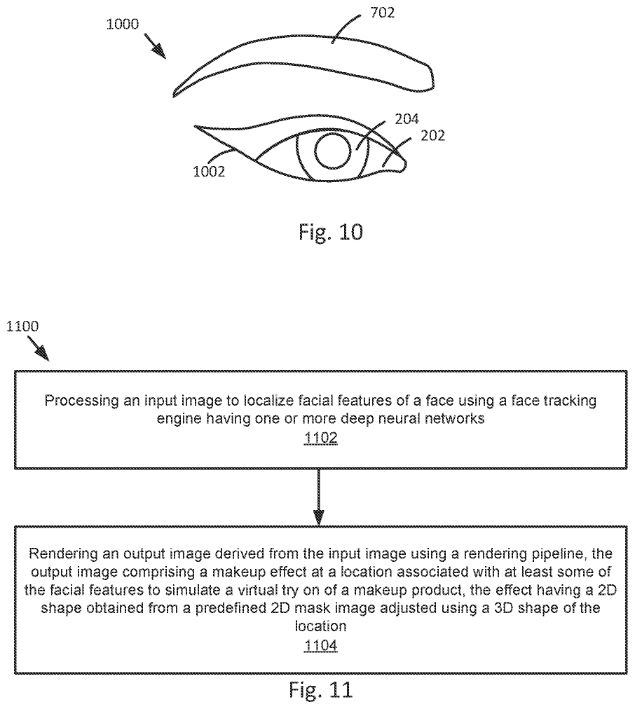

In an embodiment, a known technique for mapping can be used. For example, to “warp” a 2D mask image onto the surface of a 3D mesh, operations utilize a technique called UV Mapping. In the embodiment, a mask image references a shape for a makeup effect such as a shape for an eyeshadow applied to an eye region that may be located adjacent to a top contour of an eye and extend toward a lower contour of a brow, and extend externally of the eye. FIG. 10 is an illustration of an eye region 1000 having an eye mask 1002 in accordance with an embodiment. This mapping process can be interpreted as a paper 3D model of an object, e.g. a sphere, that is to be laid flat on a table, and each of the 3D coordinates of the object can be mapped to the 2D coordinate on the flat image. The purpose of this unwrapping of the 3D coordinates is to map these 3D coordinates to images/pictures so that the 3D image can have a realistic looking surface with textures derived from these images.

Using Eyeshadow effects as an example, the general process for mapping mask images onto 3D mesh is following: use the eye template image (e.g. mask image 1002 creating the eye makeup effect) as the texture image; unwrap 3D mesh to 2D; and adjust the 2D UV vertices so that the texture gets displayed properly onto the 3D mesh. In an embodiment, the 3D mesh can be unwrapped such as by using available third party originated software. The 2D vertices can be aligned with the mask image (e.g. giving a shape of the makeup effect) and reference points.

FIG. 11 is a flowchart of operations 1100 in accordance with an embodiment, such as for a computing device (e.g. device 302) of FIG. 3. The operations 1100 define a computer implemented method comprising executing by one or more processors the steps of a method.

For example, in a method aspect, there is provided the following mesh related embodiments: Mesh Embodiment 1: A computer implemented method comprises executing by one or more processors the steps of: processing an input image to localize facial features of a face using a face tracking engine having one or more deep neural networks (step 1102); and rendering an output image derived from the input image using a rendering pipeline, the output image comprising a makeup effect at a location associated with at least some of the facial features to simulate a virtual try on of a makeup product, the effect having a 2D shape obtained from a predefined 2D mask image adjusted using a 3D shape of the location (step 1104).

Mesh Embodiment 2: In Mesh Embodiment 1, the face tracker respectively produces face points defining a shape contour for each of the facial features localized; and the pipeline: generates a 3D mesh using a 3D model and the face points of at least some of the facial features to define the 3D shape of the location; warps the predefined 2D mask image to the 3D mesh to adjust the 2D mask image; and maps (e.g. unwraps) the 2D mask image as warped to provide the 2D shape of the makeup effect at the location.

Mesh Embodiment 3: In Mesh Embodiment 2, the pipeline performs UV mapping to map the 2D mask image as warped using the 3D mesh.

Mesh Embodiment 4: In any of Mesh Embodiments 1 to 3, the makeup effect is associated with a makeup product and the method comprises: providing, via a user interface, a recommendation of a plurality of makeup products to virtually try on; and receiving a selection input, via the user interface, selecting the makeup product for a virtual try on experience.

Mesh Embodiment 5: In any of Mesh Embodiment 1 to 4, the selection input selects one or more products for rendering one or more makeup effects at two or more locations associated with the at least some facial features; and wherein the rendering renders a first makeup effect at a first location using a first predefined 2D mask image adjusted using a 3D shape of the first location; and wherein the rendering renders a second makeup effect at a second location using a second predefined 2D mask image adjusted using a 3D shape of the second location. In an example the one or more products comprises an eye shadow, the one or more makeup effects comprises an eyeshadow effect, the first and second locations are respective left and right eye regions associated with eye and brow facial features, and the first and second predefined 2D masks images are left eye and right eye mask images, which may be one eye image and a mirror thereof.

Mesh Embodiment 6: In any of the Mesh Embodiments 1 to 5, the method comprises providing, via the user interface, a purchase service to conduct an purchase transaction (e.g. via e-commerce) to purchase a makeup product.

It will be appreciated that a system aspect and a computer program product aspect are each disclosed corresponding to each one of Mesh Embodiments 1 to 6, for example. Any one or more of the Mesh Embodiments can be combined with any one or more of the Hue Embodiments, Glitter Embodiments, and Shaping Embodiments as noted.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored herein.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer implemented method comprising executing by one or more processors the steps of:
processing a sclera in a face of an input image to determine a reference hue of the face;
adjusting a hue of a makeup effect in response to the reference hue to render an adjusted makeup effect to the input image; and
presenting an output image defined from the input image and the adjusted makeup effect via a user interface as a component of a virtual try on experience.

2. The method of claim 1 wherein the hue of the makeup effect is pushed towards a more warm tone or a more cold tone responsive to the reference hue.

3. The method of claim 1, wherein the processing adjusts a brightness and a saturation of the makeup effect in response to an average skin color determined by processing skin in the face and responsive to eye brightness determined by processing one or more eyes in the face.

4. The method of claim 1, wherein the adjusting the hue is responsive to detecting a presence of the sclera for adjusting the hue.

5. The method of claim 1, wherein the method comprises processing the image using a deep neural network to localize facial features in the face; and wherein the sclera is processed and the makeup effect is rendered in response to the facial features as localized.

6. The method of claim 1, wherein the makeup effect is associated with a makeup product and the method comprises providing, via the user interface, a recommendation of a plurality of makeup products to virtually try on; and receiving a selection input, via the user interface, selecting the makeup product for the virtual try on experience.

7. The method of claim 1, wherein the makeup effect is associated with a makeup product and the method comprises providing, via the user interface, a recommendation of a plurality of makeup products to virtually try on; and receiving a selection input, via the user interface, selecting the makeup product for the virtual try on experience; and wherein a selection input selects a plurality of products and the method comprises adjusting the hue of each associated makeup effect in response to the reference hue for rendering a plurality of adjusted make effects to the input image.

8. The method of claim 1, wherein the method comprises providing, via the user interface, a purchase service to conduct a purchase transaction to purchase one or more makeup products.

9. A computer implemented method comprising executing by one or more processors the steps of:
processing a face of an input image to determine a location of a facial feature, the input image processed by a face tracking engine comprising at least one deep neural network to localize facial features;
rendering a makeup effect in association with the facial feature, the makeup effect including a glitter effect defined from pre-computed texture and light environment maps for locating and lighting the glitter effect; and
providing an output image defined from the input image and the makeup effect for presenting via a user interface as a component of a virtual try on experience.

10. The method of claim 9, wherein the makeup effect comprises a lip makeup effect, an eye region makeup effect, or a cheek region makeup.

11. The method of claim 9, wherein the step of rendering is responsive to physical based rendering techniques to define the glitter effect.

12. The method of claim 9, wherein:
a pre-computed texture map defines, for each of a plurality of glitter particles, a glitter location and a glitter reflectance angle;
a light environment map simulates a light source for determining a specular brightness of a particular glitter particle in accordance with the reflectance angle of the particular glitter particle; and
the rendering defines pixel values for pixels of the makeup effect, adjusting a lighting up of a current pixel in accordance with a distance of the current pixel to a glitter location of a particular particle, the specular brightness of the particular glitter particle, and a size of the particular glitter particle.

13. The method of claim 12, wherein one or more of:
the specular brilliance is further determined in response to a three dimensional shape of the makeup effect and a rotation of the face; or
a size of the particular glitter particle is randomly assigned within a normalized range; or
the lighting up is further responsive to a glow alpha of the particular glitter particle, defining a light fade from a center; or
the rendering further colours the makeup effect responsive to a glitter colour of the particular glitter particle; or
the plurality of glitter particles are randomly spaced in the texture map without overlapping and wherein the rendering repeats the defining of the pixel values using the texture map in a plurality of overlapping texture map layers to overlap glitter particles in the glitter effect, and, preferably, wherein the rendering varies a glitter particle density of the glitter effect, randomly determining whether a particular particle in the texture map exists in any one of the overlapping texture map layers; or
a normal to the reflectance angle is used with the light environment map for determining spectral brilliance; or
each of the glitter locations of the plurality of glitter particles are randomly assigned using Poisson disk sampling.

14. The method of claim 9, wherein rendering is responsive to any one or more rendering effects parameters comprising color, reflection, color variation, density, intensity, size, or size variation parameters.

15. A computer implemented method comprising executing by one or more processors the steps of:
pre-computing texture and light environment maps for locating and lighting a glitter effect as a component of a makeup effect to be rendered in association with a facial feature localized by a face tracking engine of a make-up virtual try on application; and
providing the pre-computed texture and light environment maps to a rendering pipeline of the make-up virtual try on application to render to an output image for display the makeup effect having the glitter effect.

16. The method of claim 15, wherein the pre-computed texture and light environment maps are defined for generating the glitter effect in accordance with physical based rendering techniques that model the particles in a lit environment.

17. The method of claim 15, wherein a texture map is precomputed in accordance with a Voronoi Diagram technique, providing random locations for a plurality of glitter particles about the glitter effect, and the texture map is further computed to comprise respectively a reflectance angle for each of the plurality of glitter particles.

18. The method of claim 17, wherein the light environment map is defined to model a source of light, such that at a time of rendering, a specular brilliance is provided respectively for each of the plurality of glitter particles in the glitter effect, the specular brilliance responsive to the reflectance angle.

19. The method of claim 17, wherein the locations of the glitter particles are assigned using Poisson disk sampling distribution.
